(19) United States
(12) Patent Application Publication
(10) Pub. No.: US 2023/0019577 A1
(43) Pub. Date: Jan. 19, 2023

(54) METHOD, COMPUTER DEVICE, AND NON-TRANSITORY COMPUTER-READABLE RECORDING MEDIUM FOR SHARING PAYMENT INFORMATION AND SETTLEMENT

(71) Applicant: LINE Corporation, Tokyo (JP)

(72) Inventors: Ji Yeon CHEON, Seongnam-si (KR); Woo Seo SON, Seongnam-si (KR)

(73) Assignee: LINE Corporation, Tokyo (JP)

(21) Appl. No.: 17/865,827

(22) Filed: Jul. 15, 2022

(30) Foreign Application Priority Data
Jul. 16, 2021 (KR) 10-2021-0093529

(51) Int. Cl. G06Q 20/02; G06Q 20/40; G06Q 20/38

(52) U.S. Cl. CPC G06Q 20/02; G06Q 20/4015; G06Q 20/389

(57) ABSTRACT

A method of processing a settlement includes setting a chatroom for interaction with a payment method; and sending payment details using the payment method to the chatroom and sharing the payment details with a member participating in the chatroom.

### CROSS-REFERENCE TO RELATED APPLICATION(S)

This U.S. non-provisional application and claims the benefit of priority under 35 U.S.C. § 365(c) to Korean Patent Application No. 10-2021-0093529, filed Jul. 16, 2021, the entire contents of which are incorporated herein by reference in their entirety.

### BACKGROUND

### Technical Field

One or more example embodiments relate to technology for providing a financial service related to a social network service (SNS).

### Related Art

Social media refers to an open online platform that may share personal thoughts or opinions, experience, and information and may also create and expand a relationship with others based on a social network service (SNS). Such social media forms an organic relationship between users and distributes contents such that a relationship between a production and a consumption is not one-sided and users may voluntarily participate and share contents in an interactive manner.

As this SNS spreads throughout society, the SNS is used for the purpose of sharing information between groups with a common interest and the scope of use is expanding to a wide range of social domains.

In a financial field, an Internet banking service or a simple payment service may be provided in connection with an SNS. For example, a device may process banking business between users using the SNS messenger. However, such devices may not send payment details to a chatroom linked to a payment method, provide a visit record based on location information and time information of payment details shared through the chatroom, or automatically settle a payment amount based on payment details shared through the chatroom.

### SUMMARY

Some example embodiments may send payment details to a chatroom linked to a payment method during a payment to be shared in real time.

Some example embodiments may provide a visit record based on location information and time information of payment details shared through a chatroom.

Some example embodiments may automatically settle a payment amount based on payment details shared through a chatroom.

According to an aspect of at least one example embodiment, there is provided a method of processing a settlement by a computer device, the computing device including at least one processor configured to execute computer-readable instructions included in a memory.

In some example embodiments, the method, executed by the at least one processor, comprising: setting a chatroom for interaction with a payment method; and sending payment details to the chatroom based on the payment method.

In some example embodiments, the payment details sent to the chatroom include payment information created during a payment or acquired from a receipt recognition result, the payment information including at least one of location information, time information, and a payment amount.

In some example embodiments, the method further includes settling, by the at least one processor, a payment amount based on the payment details shared in the chatroom.

In some example embodiments, the settling settles the payment amount using a payment method shared in the chatroom of another member among a plurality of members participating in the chatroom.

In some example embodiments, the settling includes calculating a settlement amount for each of a plurality of members participating in the chatroom based on the payment details shared in the chatroom; and requesting each of the plurality of members transfer a payment of the settlement amount.

In some example embodiments, the settling includes receiving a selection of items among a plurality of items listed in the payment details; and calculating the payment amount based on the selection of items listed in the payment details shared in the chatroom.

In some example embodiments, the settling includes receiving a selection of a settlement target member from a list of contacts on a social network service (SNS); calculating a settlement amount for the settlement target member; and requesting the settlement target member transfer a payment of the settlement amount.

In some example embodiments, the settling includes generating, by the at least one processor, a recommended list of potential settlement target members from among a list of contacts based on location information and time information associated with the payment details shared in the chatroom.

In some example embodiments, the method further includes generating, by the at least one processor, a visit record based on the payment details shared in the chatroom.

In some example embodiments, the visit record includes one or more of a list or a map of visited places based on location information and time information included in payment information included within the payment details.

Other example embodiments relate to a non-transitory computer-readable recording medium storing instructions that, when executed by a processor, cause the processor to perform the method of processing a settlement by a computer device.

Other example embodiments relate to a computing device including a memory storing computer-readable instructions; and at least one processor configured to execute the computer-readable instructions to cause the computer device to, set a chatroom for interaction with a payment method, send payment details to the chatroom using the payment method, and settle a payment amount based on the payment details shared in the chatroom.

In some example embodiments, the payment details sent to the chatroom include payment information created during a payment or acquired from a receipt recognition result, the payment information including at least one of location information, time information, and a payment amount.

In some example embodiments, the at least one processor settles the payment amount using a payment method shared in the chatroom of another member among a plurality of members participating in the chatroom.

In some example embodiments, the at least one processor is configured to settle the payment amount based on the payment details shared in the chatroom, calculate a settlement amount for each of a plurality of members participating in the chatroom based on the payment details shared in the chatroom, and request each of the plurality of members transfer a payment of the settlement amount.

In some example embodiments, the at least one processor is configured to settle the payment amount based on the payment details shared in the chatroom by, receiving a selection of items among a plurality of items listed in the payment details; and calculating the payment amount based on the selection of items listed in the payment details shared in the chatroom.

In some example embodiments, the at least one processor is configured to settle the payment amount based on the payment details shared in the chatroom by, receiving a selection of a settlement target member from a list of contacts on a social network service (SNS); calculating a settlement amount for the settlement target member; and requesting the settlement target member transfer a payment of the settlement amount.

In some example embodiments, the at least one processor is configured to generate a recommended list of potential settlement target members from among a list of contacts based on location information and time information associated with the payment details shared in the chatroom.

In some example embodiments, the at least one processor is further configured to generate a visit record based on the payment details shared in the chatroom.

In some example embodiments, the visit record includes one or more of a list or a map of visit places based on location information and time information included in payment information included within the payment details.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 is a diagram illustrating an example of a component includable in a processor of a computer device according to at least one example embodiment;

FIG. 4 is a flowchart illustrating an example of a method performed by a computer device according to at least one example embodiment;

FIG. 5 illustrates an example of a process of interacting with a chatroom according to at least one example embodiment;

FIG. 6 illustrates an example of a process of sharing payment details in a chatroom according to at least one example embodiment;

FIG. 7 illustrates an example of a process of providing a visit record based on payment details according to at least one example embodiment;

FIG. 8 illustrates an example of a process of sharing a visit record based on payment details according to at least one example embodiment; and

FIGS. 9 and 10 illustrate examples of a process of a 1/N settlement based on payment details according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for providing a financial service related to a social network service (SNS).

Example embodiments including the disclosures herein may automatically share payment details through a chatroom and may automatically settle a payment amount based on the payment details shared through the chatroom.

A settlement processing system according to example embodiments may be implemented by at least one computer device and a settlement processing method according to example embodiments may be performed through at least one computer device included in the settlement processing system. Here, a computer program according to an example embodiment may be installed and run on the computer device, and the computer device may perform the settlement processing method according to example embodiments under control of the running computer program. The computer program may be stored in a non-transitory computer-readable recording medium to implement the settlement processing method according to example embodiments in conjunction with the computer device.

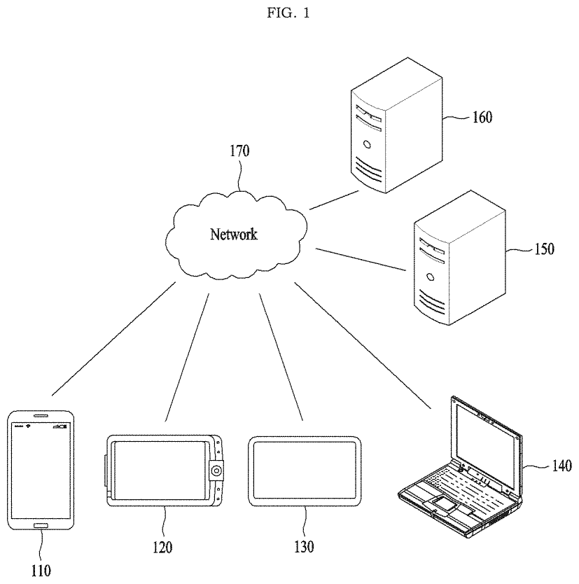

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto. Also, the network environment of FIG. 1 is described as one example among environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., a financial service) to the plurality of electronic devices 110, 120, 130, and 140 connected over the network 170.

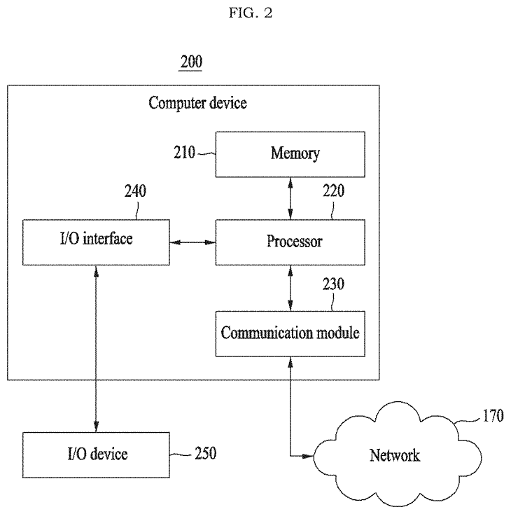

FIG. 2 is a block diagram illustrating an example of a computer device according to at least one example embodiment. Each of the plurality of electronic devices 110, 120, 130, and 140 or the servers 150 and 160 may be implemented in a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as ROM and disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files provided over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and other apparatuses, for example, the aforementioned storage devices, over the network 170. For example, the processor 220 of the computer device 200 may deliver a request or an instruction created based on a program code stored in the storage device, such as the memory 210, data, file, etc., to the other apparatuses over the network 170 under control of the communication interface 230. Inversely, a signal, an instruction, data, a file, etc., from another apparatus may be received at the computer device 200 through the network 170 and the communication interface 230 of the computer device 200. For example, a signal, an instruction, data, etc., received through the communication interface 230 may be delivered to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with a device in which an input function and an output function are integrated into a single function, such as a touchscreen. The I/O device 250 may be configured as a single device with the computer device 200.

Also, according to other example embodiments, the computer device 200 may include a number of components greater than or less than a number of components shown in FIG. 2. However, there is no need to clearly illustrate many components according to the related art. For example, the computer device 200 may include at least a portion of the I/O device 250, or may further include other components, for example, a transceiver, a database (DB), and the like.

Hereinafter, example embodiments of a method and system for sharing payment information and settlement are described.

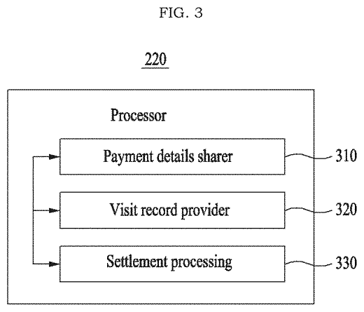

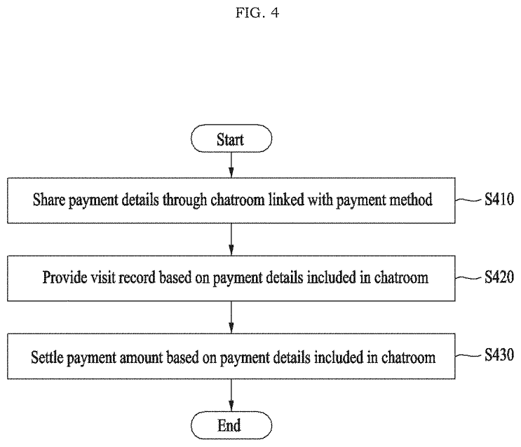

FIG. 3 is a diagram illustrating an example of a component includable by a processor of a computer device according to at least one example embodiment, and FIG. 4 is a flowchart illustrating an example of a settlement processing method performed by a computer device according to at least one example embodiment.

The computer device 200 according to the example embodiment functions as a platform that provides a financial service. A settlement processing system may be configured in the computer device 200. The computer device 200 may provide various financial services, such as a transfer and a payment, through connection to an exclusive application installed on the electronic devices 110, 120, 130, and 240 or a website/mobile site related to the computer device 200 with respect to the plurality of electronic devices 110, 120, 130, and 140 that are clients. In particular, the computer device 200 may provide a financial service combined with a sharing function through linkage to an SNS platform.

Referring to FIG. 3, the processor 220 of the computer device 200 may execute instructions that configure the processor 220 as a special purpose computer to perform the functions of a payment details sharer 310, a visit record provider 320, and a settlement processing 330 to perform the settlement processing method of FIG. 4. Depending on example embodiments, the functional components of the processor 220 may be selectively included in or excluded from the processor 220. Also, depending on example embodiments, the components of the processor 220 may be separated or merged for representations of functions of the processor 220.

The processor 220 and the components of the processor 220 may control the computer device 200 to perform operations 5410 to 5430 included in the settlement processing method of FIG. 4. For example, the processor 220 and the components of the processor 220 may be configured to execute an instruction according to a code of at least one program and a code of an OS included in the memory 210.

Here, the functional components of the processor 220 including the visit record provider 320, and settlement processing 33 may be representations of different functions performed by the processor 220 in response to an instruction provided from the program code stored in the computer device 200. For example, the payment details sharer 310 may be used as a functional representation of the processor 220 that controls the computer device 200 to share payment details in response to the instruction.

The processor 220 may read instructions from the memory 210 to which instructions associated with control of the computer device 200 are loaded. In this case, the read instructions may include instructions for controlling the processor 220 to perform the following operations 5410 to 5430.

The following operations 5410 to 5430 may be performed in order different from order illustrated in FIG. 4 and a portion of operations 5410 to 5430 may be omitted. Alternatively, an additional process may be further included.

Referring to FIG. 4, in operation 5410, the processor 220, while performing the functions of the payment details sharer 310, may link a chatroom on an SNS to a corresponding payment method through settings related to the payment method. Further, the payment details sharer 310 may send payment details to the chatroom linked to the payment method during a payment using the payment method and may share the payment details with a member participating in the chatroom.

The processor 220 may provide a financial service combined with a sharing function through linkage to an SNS platform. Here, the SNS platform may include a timeline service that displays posts as a timeline type as well as a chat service as a community function using a social graph based on a friend relation. The processor 220 may use at least one of the chat service and the timeline service provided from the SNS platform as the sharing function required in the financial service. For the sharing function, information created between each other may be shared by using an account in which a user account of an SNS (an SNS account) and a user account of the financial service (a financial account) are integrated into one or by mapping and managing the SNS account and the financial account of a user.

The payment details sharer 310 may set a chatroom selected by the user from among chatrooms on the chat service as a chatroom (hereinafter, referred to as a shared chatroom) for sharing payment details. Here, the shared chatroom may be a one-to-one chatroom or a group chatroom and may be a chatroom in which the user and at least one other member participate. The payment details sharer 310 may send payment details to the shared chatroom at time of a payment. Here, the payment details may be processed as a message type and may be displayed as an official account or a user-side outgoing message in the shared chatroom. In the SNS platform, when the payment details are received from a payment platform, information included in the payment details may be arranged according to a layout of a message user interface (UI) and may be displayed as a single message unit. The payment details gathered by the processor 220 may include location information, time information, a payment item, a payment amount, and the like, collected during a payment. In addition, the payment details may include information acquired by the processor 220 from the Internet. For example, restaurant photos or item photos may be collected and used on the Internet based on a restaurant location and an item (menu) paid by the user. The processor 220 may share such payment details in real time at a time at which a payment is made by the user and may also be shared regardless of a payment point in time. Also, according to some example embodiments, the processor 220 may perform acquire payment details using a receipt recognition result by extracting information from a receipt through, for example, an optical character reader (OCR).

In operation 5420, the processor 220, while performing the functions of the visit record provider 320, may create and provide a visit record based on the payment details included in the shared chatroom. Payment details by payment methods of different users may be included in the shared chatroom. When another member participating in the shared chatroom other than the user links a payment method of the other member to the corresponding shared chatroom, the payment method of the other member as well as the payment details using the payment method of the user may be sent to the shared chatroom and thereby shared.

For example, the visit record provider 320 may list up and provide visited places based on location information and time information included in the payment details. The visit record provider 320 may sort the visited places in order of payment time. As another example, the visit record provider 320 may provide a visit map displayed by identifying the location information included in the payment details with a pin on a map. The visit record provider 320 may create a coursed route by connecting the visited places in order of payment time. The visit record provider 320 supports a function capable of sharing a visit record in a form of a list and/or a map through various channels (e.g., an SNS timeline or other chatrooms) and a function capable of storing the visit record in a storage, such as a local or a cloud.

In operation 5430, the processor 220, while performing the functions of the settlement processing 330, may settle a payment amount based on the payment details included in the shared chatroom. The settlement processing 330 may automatically sum a payment amount in the payment details included in the shared chatroom and may proceed with a settlement for a summed amount. Here, the settlement processing 330 may sum and settle a payment amount for all the payment details included in the shared chatroom and, depending on example embodiments, may sum and settle a payment amount for some payment details selected by the user. For example, when ten cases of payment details are shared through the shared chatroom, the settlement processing 330 may select and settle some of the ten cases.

For example, the settlement processing 330 may set a member participating in the shared chatroom as a settlement target member and may request the member among a plurality of N members pay a portion, such as a 1/N, of the payment amount. As another example, the settlement processing 330 may set at least one selected from a list of friends on an SNS and may request a 1/N transfer for the payment amount. The settlement processing 330 may provide a list of members on the SNS to set the settlement target member. Here, the settlement processing 330 may display a member participating in the shared chatroom to be distinguished from others in a list of contacts. That is, the settlement processing 330 may request the 1/N transfer by excluding some members from among members participating in the shared chatroom or by adding other contacts aside from the members participating in the shared chatroom. As another example, the settlement processing 330 may request a 1/N transfer for a payment amount of a corresponding case by setting a settlement target member for each case of the payment details included in the shared chatroom. Here, members participating in the shared chatroom may share location information and the settlement processing 330 may recommend a list of contacts for setting a settlement target member based on location information shared by each member and location information and time information of payment details to be settled. For example, the settlement processing 330 may recommend a contact having visited a location adjacent to a corresponding payment place at a time at which a payment is made as a settlement target member.

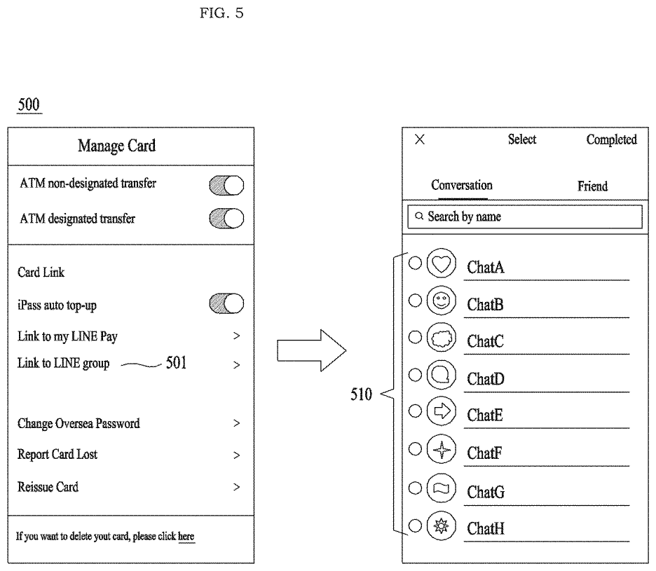

FIGS. 5 to 10 illustrate examples of a process for payment details sharing and settlement according to at least one example embodiment.

FIGS. 5 to 10 illustrate service screens displayed on a client device that is an electronic device of a user.

The processor 220 may automatically share payment details created in various meetings, such as a travel and a dinner, through a chatroom in which corresponding members participate, and may automatically determine assigned payment amounts attributable to the participants based on the payment details shared in the chatroom and may request a transfer of the assigned payment amounts from the participants. For example, if there are N participants, the processor 220 may determine the assigned payment amounts attributable to each participant to be 1/N. However, example embodiments are not limited thereto.

FIG. 5 illustrates an example of a payment method management screen 500.

Referring to FIG. 5, the payment method management screen 500 may include an interface for various environment settings related to a payment method, and may include a “chatroom link” interface 501 for setting a chatroom in which payment details is to be shared.

When the “chatroom link” interface 501 is selected on the payment method management screen 500, the processor 220 may display a list of chatrooms 510 created on an SNS in conjunction with an SNS platform.

The processor 220 may link a chatroom selected from the list of chatrooms 510 with the payment method as a chatroom for sharing the payment details. In addition to linking a chatroom created in advance on the SNS, the processor 220 may also select a meeting member from a list of friends on the SNS and may directly create and link a chatroom for sharing payment details.

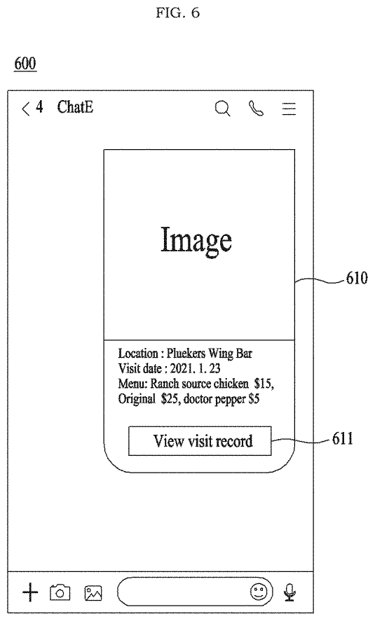

FIG. 6 illustrates an example of a shared chatroom 600 linked to a payment method.

Referring to FIG. 6, the processor 220 may send payment details to the shared chatroom 600 linked to the payment method during a payment using the payment method. The payment details may be processed as a message type and displayed in the shared chatroom 600. Here, a payment details message 610 may be displayed as an official account of a payment service or a message type sent from a user.

Therefore, the processor 220 may share the payment details with a member participating in the shared chatroom 600 by linking a payment details notification with the shared chatroom 600.

The payment details message 610 may include location information, time information, a payment item, a payment amount, etc., collected during the payment as payment information included in the payment details, and may include a “visit record” interface 611 for verifying a visit record based on the payment details.

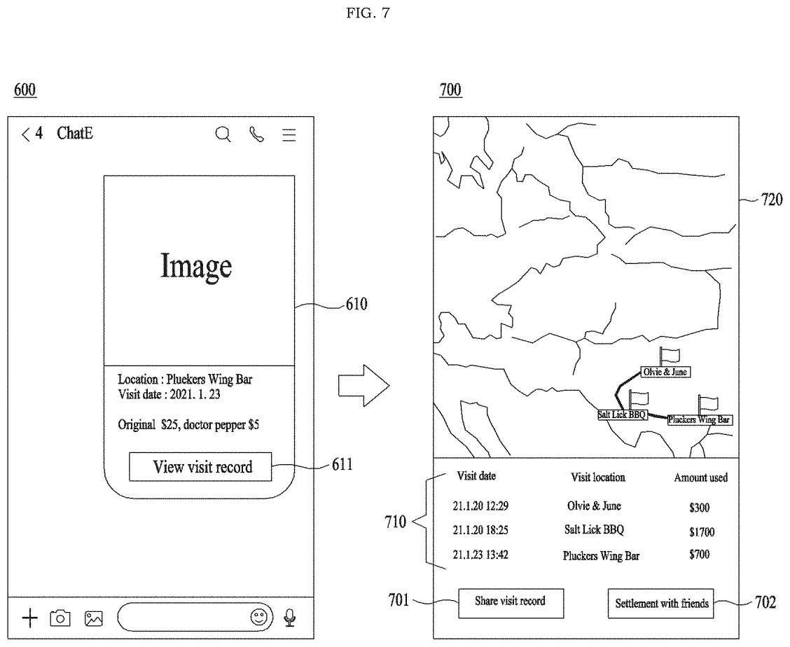

Referring to FIG. 7, when the “visit record” interface 611 in the payment details message 610 is selected in the shared chatroom 600, the processor 220 may move to a visit record screen 700.

The processor 220 may provide a list of visited places 710 and a visit map 720 as the visit record that is created based on the payment details included in the shared chatroom 600 through the visit record screen 700.

In the list of visited places 710, visited places may be sorted in order of payment time based on location information and time information included in the payment details.

The visit map 720 refers to a map that represents the location information included in the payment details and may include a route in which the visited places are indicated with pins on a map and connected in order of payment time.

Therefore, the processor 220 may create and provide the visit record in various types using the payment details shared in the shared chatroom 600.

The visit record screen 700 may include a “share” interface 701 for sharing the visit record and a “settlement” interface 702 for settling the payment details included in the shared chatroom 600.

Although not illustrated, the visit record screen 700 may include a “report” interface for reporting costs according to still another example embodiment. The user may print supporting documents with other users related to each cost through the “report” interface.

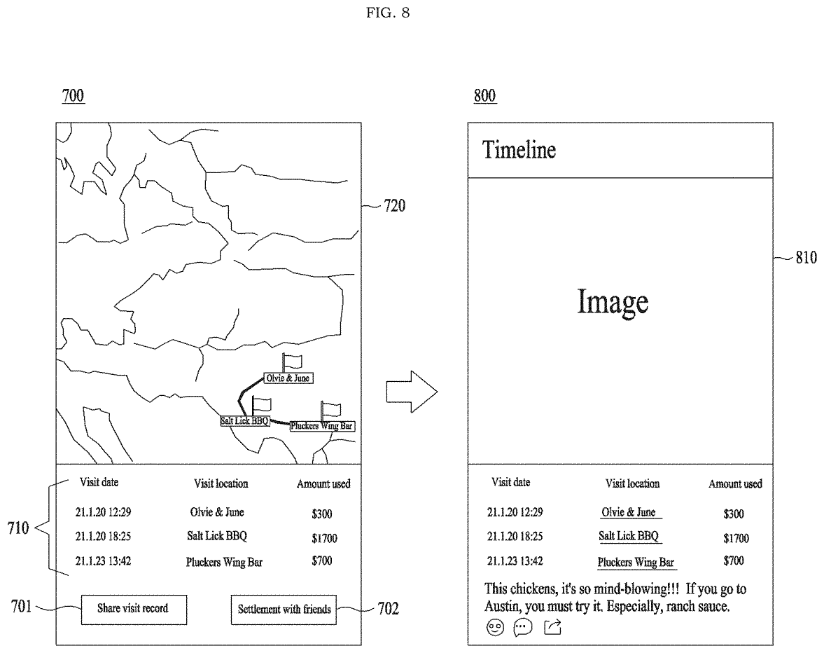

Referring to FIG. 8, when the “share visit record” interface 701 is selected from the visit record screen 700, the processor 220 may send at least one of the list of visited places 710 and the visit map 720 to the SNS platform and may request the same to be posted as a timeline post 810 of the user on a timeline service screen 800.

When sharing the visit record, the processor 220 may share information (e.g., an image, etc.) acquired on the Internet in addition to the payment information created during a payment, as information included in the payment details.

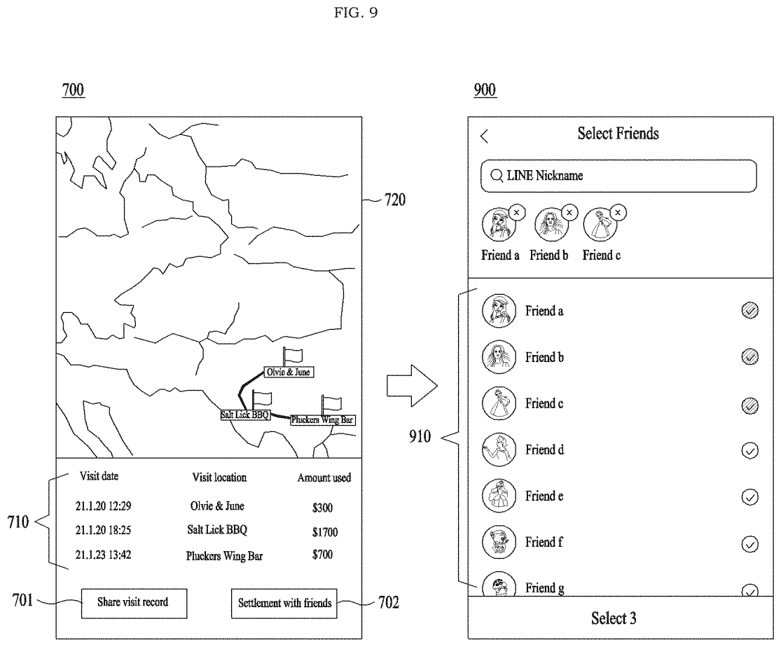

Referring to FIG. 9, when the “settlement” interface 720 is selected on the visit record screen 700, the processor 220 may move to a settlement processing screen 900.

For example, the processor 220 may provide a list of contacts (or, alternatively, friends) 910 for setting a settlement target member through the settlement processing screen 900. The list of contacts 910 may be configured as a list of contacts on the SNS. Here, in the list of contacts 910, a member participating in the shared chatroom 600 may be displayed to be distinguished from other contacts. For example, a member participating in the shared chatroom 600 in the list of contacts 910 may be displayed in a state in which the member is selected as a settlement target member.

Through the list of contacts 910, the processor 220 may exclude some of members participating in the shared chatroom 600 from settlement target members or may add another member in addition to the members participating in the shared chatroom 600 as a settlement target member.

Also, the processor 220 may display a contact having visited a location adjacent to a payment place at a time at which a payment is made to be distinguished from other contacts in the list of contacts 910 for the payment details included in the shared chatroom 600. That is, the processor 220 may recommend a contact for setting a settlement target member based on location information and time information of payment details to be settled.

When setting of the settlement target member is completed through the list of contacts 910, the processor 220 may automatically sum a payment amount in the payment details included in the shared chatroom 600 and may proceed with a settlement (e.g., a 1/N settlement) for a summed amount.

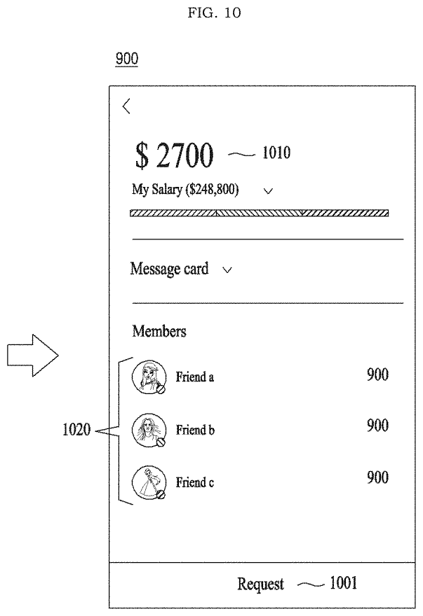

Referring to FIG. 10, the processor 220 may display an amount 1010 automatically summed from the payment details included in the shared chatroom 600 through the settlement processing screen 900.

The processor 220 may display a list of settlement target members 1020 set through the list of contacts 910 and may divide the summed amount 1010 by the number of contacts N and then display an amount, such as 1/N, to be shared by each settlement target member.

When a “settlement request” interface 1001 is selected on the settlement processing screen 900, the processor 220 may send a transfer request for each amount to be settled to a one-to-one chatroom (or, alternatively, a private message) with each settlement target member for each settlement target member.

Although it is described that a settlement is performed for all the payment details included in the shared chatroom 600, it is provided as an example only. The settlement may be performed for remaining cases of payment details after excluding some cases of payment details selected by the user from among the payment details included in the shared chatroom 600. Also, the settlement may be performed for a payment amount of a corresponding case by setting a settlement target member for each case of the payment details included in the shared chatroom 600.

Therefore, the processor 220 may efficiently process a settlement with a settlement target member by determining a target to be settled based on the payment details shared in the shared chatroom 600 and by automatically summing an amount to be settled.

According to some example embodiments, a user may have no need to directly write a message including payment details and to deliver the message to each of members and, instead, may share the payment details with the members by automatically sending the payment details to a chatroom linked with a payment method during a payment. Therefore, it is possible to efficiently use a networking resource.

Also, according to some example embodiments, it is possible to create and provide a visit record based on location information and time information of payment details shared through a chatroom, and to automatically settle a payment amount based on the payment details shared through the chatroom and to request a settlement target member to transfer the payment amount through the chatroom. Therefore, it is possible to provide more accurate data to a user and to provide enhanced user experience.

The systems or apparatuses described above may be implemented using hardware components, software components, and/or a combination thereof. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above-described example embodiments may be configured in a form of program instructions performed through various computer devices and recorded in non-transitory computer-readable media. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A method of processing a settlement by a computer device, the computing device including at least one processor configured to execute computer-readable instructions included in a memory, the method, executed by the at least one processor, comprising:
setting a chatroom for interaction with a payment method; and
sending payment details to the chatroom based on the payment method.

2. The method of claim 1, wherein the payment details sent to the chatroom include payment information created during a payment or acquired from a receipt recognition result, the payment information including at least one of location information, time information, and a payment amount.

3. The method of claim 1, further comprising:
settling, by the at least one processor, a payment amount based on the payment details shared in the chatroom.

4. The method of claim 3, wherein the settling settles the payment amount using a payment method shared in the chatroom of another member among a plurality of members participating in the chatroom.

5. The method of claim 3, wherein the settling comprises:
calculating a settlement amount for each of a plurality of members participating in the chatroom based on the payment details shared in the chatroom; and
requesting each of the plurality of members transfer a payment of the settlement amount.

6. The method of claim 3, wherein the settling comprises:
receiving a selection of items among a plurality of items listed in the payment details; and
calculating the payment amount based on the selection of items listed in the payment details shared in the chatroom.

7. The method of claim 3, wherein the settling comprises:
receiving a selection of a settlement target member from a list of contacts on a social network service (SNS);
calculating a settlement amount for the settlement target member; and
requesting the settlement target member transfer a payment of the settlement amount.

8. The method of claim 3, wherein the settling comprises:
generating, by the at least one processor, a recommended list of potential settlement target members from among a list of contacts based on location information and time information associated with the payment details shared in the chatroom.

9. The method of claim 1, further comprising:
generating, by the at least one processor, a visit record based on the payment details shared in the chatroom.

10. The method of claim 9, wherein the visit record includes one or more of a list or a map of visited places based on location information and time information included in payment information included within the payment details.

11. A non-transitory computer-readable recording medium storing instructions that, when executed by a processor, cause the processor to perform the method of claim 1.

12. A computer device comprising:
a memory storing computer-readable instructions; and
at least one processor configured to execute the computer-readable instructions to cause the computer device to,
set a chatroom for interaction with a payment method,
send payment details to the chatroom using the payment method, and
settle a payment amount based on the payment details shared in the chatroom.

13. The computer device of claim 12, wherein the payment details sent to the chatroom include payment information created during a payment or acquired from a receipt recognition result, the payment information including at least one of location information, time information, and a payment amount.

14. The computer device of claim 12, wherein the at least one processor causes the computer device to settle the payment amount using a payment method shared in the chatroom of another member among a plurality of members participating in the chatroom.

15. The computer device of claim 12, wherein the at least one processor is configured to cause the computer device to settle the payment amount based on the payment details shared in the chatroom by,
calculating a settlement amount for each of a plurality of members participating in the chatroom based on the payment details shared in the chatroom, and
requesting each of the plurality of members transfer a payment of the settlement amount.

16. The computer device of claim 12, wherein the at least one processor is configured to cause the computer device to settle the payment amount based on the payment details shared in the chatroom by,
receiving a selection of items among a plurality of items listed in the payment details; and
calculating the payment amount based on the selection of items listed in the payment details shared in the chatroom.

17. The computer device of claim 12, wherein the at least one processor is configured to cause the computer device to settle the payment amount based on the payment details shared in the chatroom by,
receiving a selection of a settlement target member from a list of contacts on a social network service (SNS);
calculating a settlement amount for the settlement target member; and
requesting the settlement target member transfer a payment of the settlement amount.

18. The computer device of claim 12, wherein the at least one processor is configured to cause the computer device to,
generate a recommended list of potential settlement target members from among a list of contacts based on location information and time information associated with the payment details shared in the chatroom.

19. The computer device of claim 12, wherein the at least one processor is further configured to cause the computer device to generate a visit record based on the payment details shared in the chatroom.

20. The computer device of claim 19, wherein the visit record includes one or more of a list or a map of visit places based on location information and time information included in payment information included within the payment details.
